(19) United States
(12) Patent Application Publication
(10) Pub. No.: US 2003/0099019 A1
(43) Pub. Date: May 29, 2003

(54) Compensation of chromatic dispersion using cascaded etalons of variable reflectivity

(76) Inventors: Qin Zhang, San Jose, CA (US); Jason T. Yang, Cupertino, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/099,413

(22) Filed: Mar. 15, 2002

Related U.S. Application Data
(60) Provisional application No. 60/311,498, filed on Aug. 10, 2001.

(51) Int. Cl. H04B 10/18; G02B 6/26

(52) U.S. Cl. 359/161; 385/39

(57) ABSTRACT

A dispersion compensation system includes a number of etalons cascaded in series to form a chain. The chain of etalons introduces a cumulative group delay that compensates for chromatic dispersion. At least one of the etalons is tunable, thus allowing the system to be tuned, for example to compensate for different amounts of dispersion and/or manufacturing variations.

### CROSS-REFERENCE TO RELATED APPLICATIONS

This application is related to co-pending U.S. patent application Ser. No. ______, “Etalons with Variable Reflectivity,” by Qin Zhang, filed Feb. 27, 2002.

This application claims priority under 35 U.S.C. §119(e) to U.S. Provisional Patent Application Serial No. 60/311,498, “Method and Apparatus for Tunable Chromatic Dispersion Based on Gradient Reflectivity Etalons,” by Qin Zhang and Jason T. Yang, filed Aug. 10, 2001.

The subject matter of all of the foregoing is incorporated herein by reference in its entirety.

### BACKGROUND OF THE INVENTION

1. Field of the Invention

This invention relates generally to compensation of chromatic dispersion. More specifically, this invention relates to the use of a chain of etalons to compensate for chromatic dispersion.

2. Description of the Related Art

As the result of recent advances in technology and an ever-increasing demand for communications bandwidth, there is increasing interest in optical communications systems, especially fiber optic communications systems. This is because optical fiber is a transmission medium that is well-suited to meet the demand for bandwidth. Optical fiber has a bandwidth which is inherently broader than its electrical counterparts. At the same time, advances in technology have increased the performance, increased the reliability and reduced the cost of the components used in fiber optic systems. In addition, there is a growing installed base of laid fiber and infrastructure to support and service the fiber.

However, even fiber optic systems have limits on price and performance. Chromatic dispersion is one basic phenomenon which limits the performance of optical fibers. The speed of a photon traveling along an optical fiber depends on the index of refraction of the fiber. Because the index of refraction is slightly dependent on the frequency of light, photons of different frequencies propagate at different speeds. This effect is commonly known as chromatic dispersion. Chromatic dispersion causes optical signal pulses to broaden in the time domain. In addition, chromatic dispersion is cumulative in nature. Therefore, optical signals which travel longer distances will experience more chromatic dispersion. This limits the signal transmission distance over which high bit rate signals can be transmitted, even with the use of narrow linewidth lasers and low chirp external modulators. For instance, signals at 10 Gbps can travel roughly 80 km in a standard SMF-28 single mode fiber before adjacent digital bits start to interfere with each other. At 40 Gbps, this distance is reduced to 6 km. Chromatic dispersion is a significant problem in implementing high speed optical networks.

Several different approaches have been proposed to compensate for the effects of chromatic dispersion and, therefore, extend the signal transmission distance. They include systems based on dispersion compensating fiber, fiber Bragg gratings, virtual imaged phased arrays, photonic integrated circuits and etalons.

Dispersion compensating fibers (DCF) are optical fibers which have chromatic dispersion which is opposite in sign to the chromatic dispersion in “normal” fibers. Thus, propagation through a length of DCF cancels the chromatic dispersion which results from propagating through standard single mode fiber. At the present time, DCF is one of the leading commercial technologies for the compensation of chromatic dispersion and a significant number of chromatic dispersion compensating devices is based on DCF. However, DCF has several significant disadvantages. First, long lengths of DCF are required to compensate for standard fiber. For example, a typical application might require 1 km of DCF for every 5 km of standard fiber. Thus, 100 km of standard fiber would require 20 km of DCF. These amounts of DCF are both expensive and bulky. Second, DCF solutions are static. A 20 km length of DCF will introduce a specific amount of dispersion compensation. If more or less is required, for example due to changes in the overall network architecture, a different DCF solution must be engineered. The existing 20 km of DCF cannot be easily “tuned” to realize a different amount of dispersion compensation. As a final example, DCF is a type of fiber and suffers from many undesirable fiber characteristics, typically including undesirable fiber nonlinearities and high losses. A 20 km length of fiber can introduce significant losses.

Fiber Bragg gratings (FBG) have emerged over the past few years as a promising candidate for the compensation of chromatic dispersion. A fiber Bragg grating is a length of fiber into which Bragg gratings have been formed. Various groups have proposed different architectures for using FBGs to compensate for chromatic dispersion. For example, see FIG. 1 in C. K. Madsen and G. Lenz, “Optical all-pass filters for phase response design with applications for dispersion compensation,” IEEE Photonics Technology Letters, vol. 10, no. 7, July 1998, pp. 994-996. However, practical implementation of FBG solutions remains difficult. Engineering limitations have resulted in less than acceptable dispersion compensation. Finding reproducible and reliable processes to make a dispersion compensator based on FBGs remains very challenging. In addition, Bragg gratings are inherently narrow band devices so FBG-based dispersion compensators typically have a narrow operating bandwidth. It is also difficult to tune FBGs to achieve different amounts of dispersion compensation.

Architectures based on planar waveguides have also been proposed. For example, the paper referenced above suggests an approach for compensating for chromatic dispersion using an all-pass filter approach based on ring structures in planar waveguides. However, this approach is inherently expensive and polarization sensitive.

Finally, around 1990, it was disclosed that the phase response of a single etalon has a nonlinear relationship with frequency. See L. J. Cimini Jr., L. J. Greenstein and A. A. M. Saleh, “Optical equalization to combat the effects of laser chirp and fiber dispersion,” J. Lightwave Technology, vol. 8, no. 5, May 1990, pp. 649-659. Furthermore, it was proposed that an etalon could be used to compensate for chromatic dispersion. Since that time, various etalon-based architectures have been suggested. However, most, if not all, of these architectures suffer from significant drawbacks. Many of them simply cannot attain the necessary performance. They often suffer from too much group delay ripple (e.g., >20 ps) and/or too narrow an operating bandwidth. In addition, most designs are static. The designs cannot be easily tuned to achieve different amounts of dispersion compensation.

Thus, there is a need for dispersion compensation systems which can be tuned to achieve different amounts of dispersion compensation. It is also desirable for these systems to operate over a large bandwidth and to be capable of achieving low group delay ripple.

### SUMMARY OF THE INVENTION

The present invention overcomes the limitations of the prior art by providing a dispersion compensation system in which one or more etalons (preferably two or more) are cascaded in series to form a chain. The chain of etalons introduces a cumulative group delay that compensates for chromatic dispersion. At least one of the etalons is tunable, thus allowing the system to be tuned, for example to compensate for different amounts of dispersion and/or manufacturing variations.

In one implementation, the dispersion compensation system includes a chain of at least one etalon stage. Each etalon stage includes an input port, an output port, an optical path from the input port to the output port; and an etalon located in the optical path. The etalon has a front dielectric reflective coating and a back dielectric reflective coating. In at least one etalon stage, the front reflective coating of the etalon has a reflectivity that varies according to location and a point of incidence of the optical path on the front reflective coating is tunable. The cumulative chromatic dispersion of the chain of etalon stages is substantially constant over an operating bandwidth. If the dispersion compensation system is used in an application with a predefined periodic spacing of wavelength bands (e.g., the channel spacing of the ITU grid as defined in ITU G.692 Annex A of COM 15-R 67-E), the etalons can be designed so that their free spectral ranges are approximately equal to the spacing of the wavelength bands.

In one embodiment, there are three or more etalon stages, each of which is tunable. The etalons may be tunable in reflectivity, in optical path length through the etalon, or in both. In one case, the reflectivity can be adjusted by tuning the point of incidence of the optical path on the front reflective coating (which has reflectivity that varies by location) and the optical path length can be adjusted by tuning the temperature of the etalon. By tuning both of these parameters, the cumulative chromatic dispersion of the chain of etalon stages can be tuned to different values.

For example, the system could also include a lookup table that tabulates reflectivity and optical path length (or, equivalently, point of incidence and temperature) for each stage as a function of the cumulative chromatic dispersion. When a certain amount of chromatic dispersion is desired, the lookup table is used to set the stages to the corresponding values of reflectivity and optical path length.

In one implementation, the tunable etalon stages include a beam displacer for changing the point of incidence. One example of a beam displacer is a rotatable, transparent body. The optical path enters the transparent body through an input surface and exits the transparent body through an output surface and directed to the etalon. When the transparent body is rotated about an axis perpendicular to a direction of propagation of the optical path, the point of incidence is translated to different locations on the front reflective coating of the etalon.

Other aspects of the invention include methods corresponding to the devices and systems described above.

### BRIEF DESCRIPTION OF THE DRAWING

The invention has other advantages and features which will be more readily apparent from the following detailed description of the invention and the appended claims, when taken in conjunction with the accompanying drawing, in which:

FIG. 1 is a block diagram of a dispersion compensation system according to the invention.

FIG. 2 is a perspective view of a variable reflectivity etalon.

FIG. 3A is a graph of group delay as a function of frequency for a single variable reflectivity etalon.

FIG. 3B is a graph of group delay as a function of wavelength illustrating the periodic nature of the group delay function.

FIG. 4 is a graph of group delay as a function of wavelength for a three-etalon dispersion compensation system.

FIG. 5 is a table listing parameters for realizing different values of chromatic dispersion.

FIG. 6 is a graph of dispersion tuning range in a channel pass band as a function of wavelength.

FIGS. 7A-7B are side views of variable reflectivity etalons having a top layer with continuously variable thickness.

FIG. 8 is a side view of a variable reflectivity etalon having a top layer with stepwise variable thickness.

FIG. 9A is a graph of reflectivity as a function of layer thickness.

FIG. 9B is a graph of phase shift and wavelength shift in spectral response as a function of layer thickness.

FIG. 10 is a side view of a variable reflectivity etalon with constant optical path length.

FIGS. 11A-11C are side views of a variable reflectivity etalon illustrating one method for manufacturing the etalon.

FIG. 12 is a top view of an etalon stage in which an optical beam is translated relative to a stationary variable reflectivity etalon.

FIG. 13 is a top view of an etalon stage in which a variable reflectivity etalon is translated relative to a stationary optical beam.

FIGS. 14A-14B are a perspective view and top view of an etalon stage that utilizes a rotatable beam displacer.

FIGS. 15A-15B are top views of an etalon stage that utilizes a moveable reflective beam displacer.

FIG. 16 is a top view of an etalon stage that utilizes a MEMS beam displacer.

FIG. 17 is a top view of an etalon stage that utilizes separate input and output fibers.

FIG. 18 is a top view of an etalon stage that utilizes a free space circulator and a dual fiber collimator.

### DETAILED DESCRIPTION OF THE PREFERRED EMBODIMENTS

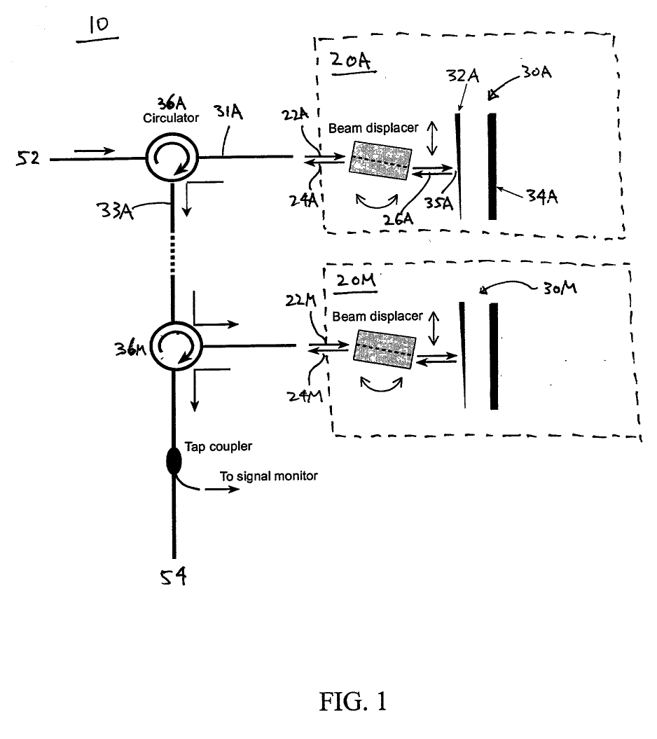

FIG. 1 is a block diagram of a dispersion compensation system 10 according to the invention. The system includes at least one etalon stage 20A-20M, preferably two or more. Each etalon stage 20 includes an input port 22, an output port 24 and an etalon 30. Within the etalon stage 20, light travels along an optical path 26 from the input port 22, through the etalon 30 to the output port 24.

The etalon stages 20 are cascaded to form a chain. In particular, the output port 24A of etalon stage 20A is coupled to the input port 22B of the next etalon stage 20B in the chain, and so on to the last etalon stage 20M. The input port 22A of the first etalon stage 20A serves as the input of the overall system 10 and the output port 24M of the last etalon stage 20M serves as the output of the overall system 10.

In the example of FIG. 1, the input ports 22 and output ports 24 are collocated. More specifically, incoming light arrives via fiber 31 and outgoing light exits via the same fiber 31, but propagating in the opposite direction. A circulator 36 is used to separate the incoming and outgoing beams. Thus, light propagates through the overall system 10 as follows. Light enters the system 10 at input 52 and is directed by circulator 36A via fiber 31A to etalon stage 20A. Within the etalon stage 20A, the light is incident upon etalon 30A at point 35A. Upon exiting etalon stage 20A, the light reenters fiber 31A to circulator 36A. Circulator 36A directs the light to fiber 33A and the next etalon stage 20B. The light propagates through the etalon stages 20 until it finally exits at output 54.

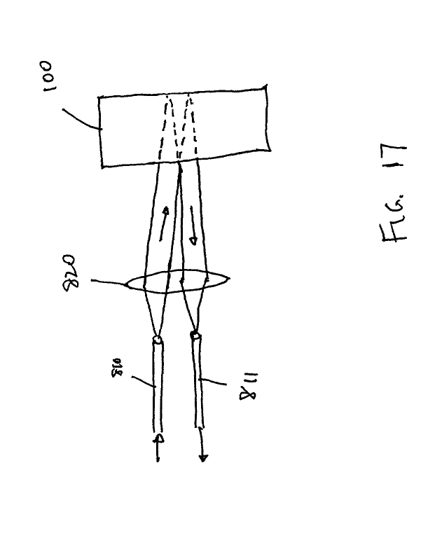

The etalon stages 20 can be coupled by devices other than a circulator 36. In cases where the input port 22 and output port 24 are collocated, different devices can be used to separate the incoming and outgoing beams. This general class of device shall be referred to as 3 dB couplers since they typically introduce an inherent 6 dB loss (3 dB on each pass through the device). Some examples of 3 dB couplers include circulators, waveguide couplers, and fiber couplers. In another embodiment, the input port 22 and output port 24 are physically separated. For example, the incoming beam may arrive on one fiber and the outgoing beam on a different fiber. See FIG. 17 below for an example of this approach. In the example of FIG. 17, a dual fiber collimator is used to connect one etalon stage to the next and can have significantly less loss than a 3 dB coupler.

Each etalon 30 has a front dielectric reflective coating 32 and a back dielectric reflective coating 34. In at least one of the etalon stages 20, a point of incidence 35 of the optical path 26 on the front reflective coating 32 is tunable, meaning that the point of incidence 35 can be moved to different locations on the front reflective coating 32. The front reflective coating 32 of this particular etalon 30 has a reflectivity that varies according to location. Thus, the effective reflectivity of the etalon 30 can be adjusted by adjusting the point of incidence 35.

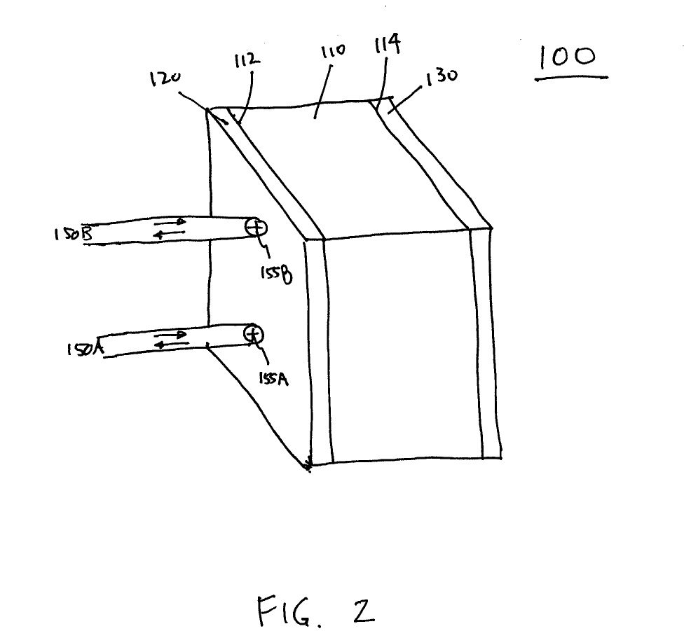

FIG. 2 is a perspective view of such a variable reflectivity etalon 100. The etalon 100 includes a transparent body 110 having a front surface 112 and a back surface 114. The front surface 112 and back surface 114 are substantially plane-parallel.

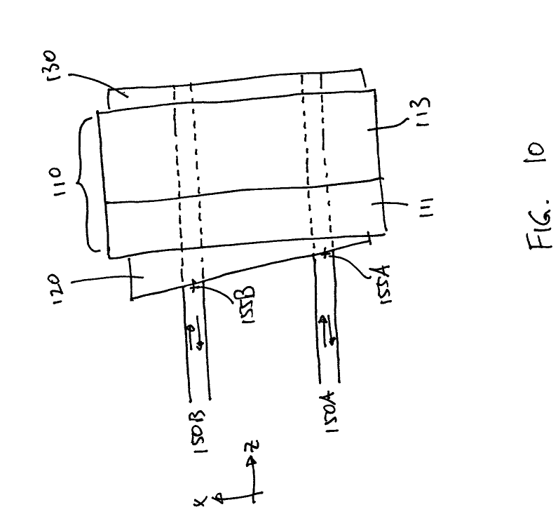

In one implementation, the transparent body 110 is made from a single block of material, as is suggested by FIG. 1. In another implementation, the transparent body 110 is made from blocks of different materials. For example, different materials may be bonded together to form a sandwich-type structure for the transparent body 110 (e.g., see FIG. 10). Alternately, some or all of the transparent body 110 may be formed by an air space or liquid crystals. In one implementation, in order from front surface 112 to back surface 114, the transparent body 110 consists of a first block of material, an air space, and a second block of material. The air space is maintained by spacers between the two blocks of material.

The front and back surfaces 112 and 114 are substantially plane-parallel in the sense that an optical beam 150 which is normally incident upon the front surface 112 also strikes the back surface 114 at an approximately normal angle of incidence. As will be seen in the examples below, it is not essential that the two surfaces 112 and 114 be exactly plane or exactly parallel. In typical cases, a parallelism of better than 0.5 arcsecond is sufficient although actual tolerances will vary by application. Furthermore, in certain cases, the optical path of a beam 150 through the etalon 100 may not be a straight line, For example, the optical beam 150 may be refracted through an angle at an internal interface in the etalon 100, or the optical path may be folded to form a more compact device by using mirrors, prisms or similar devices. In these cases, the front and back surfaces 112 and 114 may not be physically plane-parallel but they will still be optically plane-parallel. That is, the surfaces 112 and 114 would be physically plane-parallel if the optical path were unfolded into a straight line.

A back dielectric reflective coating 130 (labeled as back reflective coating 34 in FIG. 1) is disposed upon the back surface 114. The coating 130 has a reflectivity which is substantially 100%. A reflectivity somewhere in the range of 90-100% is typical, although the actual reflectivity will vary by application. If the reflectivity of back coating 130 is less than 100%, then light which is transmitted by the back coating 130 can be used to monitor the etalon 100. In applications where higher loss can be tolerated or the optical beam exits at least partially through the back surface 114, the reflectivity of back coating 130 can be significantly less than 100%. A front dielectric reflective coating 120 (labeled as coating 32 in FIG. 1) is disposed upon the front surface 112. The front reflective coating 120 has a reflectivity that varies according to location on the front surface 112.

The etalon 100 functions as follows. An optical beam 150 is incident upon the front surface 112 of the etalon 100 at a normal angle of incidence. The reflectivity of the etalon surfaces 112 and 114 results in multiple beams which interfere, thus producing etalon behavior. If the incoming optical beam is perfectly normal to the etalon's front surface 112 and the two surfaces 112 and 114 (and the coatings 120 and 130) are perfectly plane parallel, the output beam will exit the etalon 100 at the same location as the original point of incidence and will be collinear with the incoming beam 150 (but propagating in the opposite direction). The incoming and outgoing beams may be spatially separated at front surface 112 by introducing a slight tilt to the beam 150.

FIG. 2 shows two different positions for optical beam 150. In position A, the optical beam 150A strikes the front surface 112 at point of incidence 155A. In position B, the point of incidence is 155B. As will be shown below, different approaches can be used to tune the point of incidence to different locations on the etalon's front surface 112 while maintaining normal incidence of the optical beam. Typically, in a packaged stage, the optical beam 150 arrives via an input port, propagates into the etalon 100 and exits via an output port. In one class of approaches, the input port and/or the etalon 100 are moved in order to tune the point of incidence 155 to different locations. In another class of approaches, the input port and etalon 100 are fixed relative to each other, but a separate beam displacer tunes the point of incidence 155 of the optical beam on the etalon 100.

At the two different points of incidence 155A and 155B, the front reflective coating 120 has a different reflectivity. Therefore, optical beam 150A is affected differently by etalon 100 than optical beam 150B. In effect, the reflectivity of the etalon can be adjusted by varying the point of incidence 155.

The dispersion D introduced by an etalon 100 can be calculated using conventional principles. In particular, the phase modulation φ introduced by etalon 100 is given by

$$φ = 2 {tan}^{- 1} ( \frac{r sin ω T}{1 + r cos ω T} ) \qquad ( 1 )$$

where r²=R is the reflectivity of the front coating 120, the back coating 130 is assumed to be 100% reflective, T is the round-trip delay induced by the etalon, and ω is the frequency of the optical beam 150. Specifically, T=OPL/c where c is the speed of light in vacuum and OPL is the total optical path length for one round trip through the etalon 100. If the one-way optical path through the etalon is a straight line of length L through material of refractive index n, then OPL=2 nL. The group delay resulting from Eqn. (1) is

$$τ ( ω ) = - \frac{ⅆ φ ( ω )}{ⅆ ω} = - 2 rT \frac{r + cos ω T}{1 + {r}^{2} + 2 r cos ω T} \qquad ( 2 )$$

The dispersion D of the etalon is then

$$D ( λ ) = \frac{ⅆ τ ( λ )}{ⅆ λ} \qquad ( 3 )$$

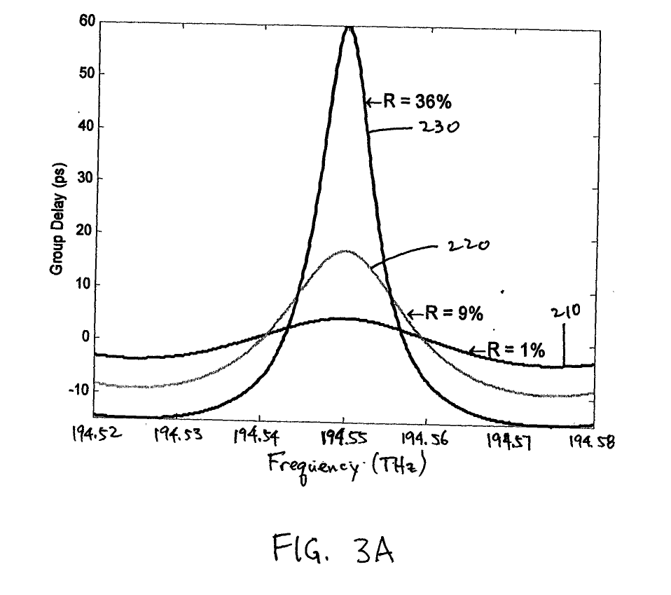

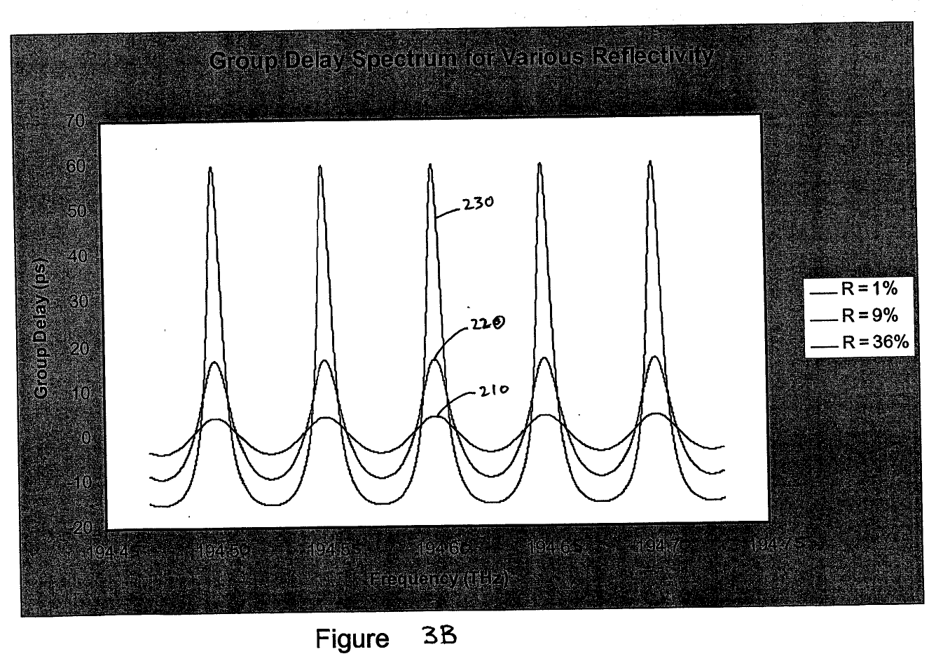

FIG. 3A is a graph of the group delay τ(ω) as a function of frequency f for three different values of the reflectivity R=r² where ω=2πf=2πc/λ where λ is the wavelength of the optical beam 150 and f the frequency. The curves 210, 220 and 230 correspond to reflectivity values R of 1%, 9% and 36%. The optical path length OPL is assumed to be constant for these curves. The different values of R are realized by varying the point of incidence 155 of the optical beam 150. For example, the point of incidence 155A in FIG. 2 might have a reflectivity R of 1%, resulting in dispersion D corresponding to the group delay curve 210. Similarly, point 155B might correspond to curve 220 and some other point of incidence might correspond to curve 230. Therefore, the group delay and the dispersion experienced by the optical beam 150 as it propagates through etalon 100 can be varied by varying the point of incidence 155. Note that in this application, the front and back reflective coatings 120 and 130 cannot be metallic since metallic coatings result in unpredictable phase modulation and the dispersion D depends on the phase modulation φ.

Furthermore, the group delay τ(ω) and dispersion D are periodic functions of the wavelength λ. The base period of these functions (also known as the free spectral range of the etalon) is set by the optical path length OPL. FIG. 3B is a graph of the group delay over a broader range of wavelengths (as compared to the graphs in FIG. 3A), illustrating the periodic nature of the function. In general, there is a single maximum and minimum for the group delay function in each period. Both the location of the maxima (or minima) and the free spectral range can be adjusted by changing the OPL. The location of the maxima and minima are sensitive to changes in the phase of the OPL. Significantly changing the free spectral range requires much larger changes in the value of OPL.

The design and selection of materials for etalon 100 depends on the wavelength λ of the optical beam 150, as well as considerations such as the end application, manufacturability, reliability and cost. Current fiber optic communications systems typically use wavelengths in either the 1.3 μm or 1.55 μm ranges and etalons intended for these systems would use corresponding materials. Obviously, the term “transparent body 110” means transparent at the wavelength of interest.

In one example, the etalon 100 is designed for use in the 1.55 μm wavelength range. The incoming optical beam 150 has a center wavelength (or multiple center wavelengths if the optical beam is wavelength division multiplexed) which is consistent with the ITU grid, as defined in the ITU standards.

The body 110 is a single block of optical purity glass, for example fused silica or BK7 glass. The length of body 110 is selected so that the free spectral range of the etalon 100 is matched to the basic periodicity of the ITU grid. For example, the ITU grid defines wave bands which are spaced at 100 GHz intervals. In one application, a fiber optic system implements one data channel per wave band and the free spectral range of the etalon 100 is 100 GHz, thus matching the ITU grid and the spacing of the data channels. In another application, two data channels are implemented in each wave band. The spacing between data channels is then 50 GHz, or half the band to band spacing on the ITU grid. The etalon 100 is designed to have a free spectral range of 50 GHz, thus matching the spacing of the data channels. The etalon can be designed to have a free spectral range that matches other periodicities, including those based on standards other than the ITU standards or those which are intentionally different than the ITU standards. For example, the etalon 100 may be intended for an application consistent with the ITU grid but the free spectral range of the etalon 100 may be different than the ITU periodicity in order to introduce variation in the etalon response from one band to the next. The front and back surfaces 112 and 114 are plane-parallel to within 0.5 arc seconds, typically. The back reflective coating 130 is a Bragg reflector with enough layers to achieve a reflectivity of over 99%

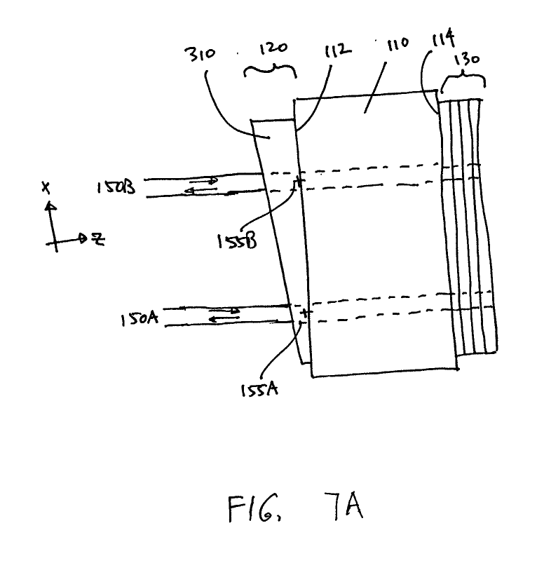

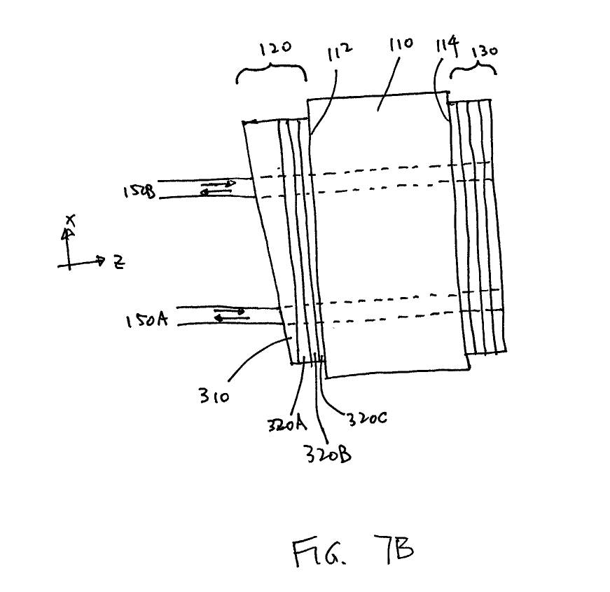

The front reflective coating 120 is a stack containing one or more layers of materials, as shown in the designs of FIGS. 7A and 7B. The detailed structure of the layers determines the range of reflectivities achievable by the front reflective coating 120 and depends on the application. In one embodiment, the front reflective coating 120 contains a single layer 310, as shown in FIG. 7A. The single layer 310 is Ta₂O₅ and has a thickness variation of a quarter wave of optical thickness. In other words, the thickest portion of the layer 310 is a quarter wave thicker than the thinnest portion. The corresponding reflectivity varies monotonically over a range from 4%-25%. If the thickness variation stays within a quarter wave (i.e., from zero to a quarter wave, or from a quarter wave to a half wave) then the reflectivity will be a monotonic function of thickness.

In another embodiment, the front reflective coating 120 is a stack of three layers, following the design of FIG. 7B (although the specific example in FIG. 7B shows four layers). Working away from the etalon body, the first two layers are quarter wave layers of Y₂O₃ and SiO₂, respectively, having refractive indices of 1.75 and 1.44. The top layer is Ta₂O₅ with a refractive index of 2.07. The thickness of the top layer varies from zero to a quarter wave. The resulting reflectivity of the front reflective coating varies over a range from 0%-40%.

Typically, by varying the thickness of top layer 310, a reflectivity variation of 40%-50% can be achieved. This variation can be translated to different offsets (e.g., to a range of 10%-60%, or 20%-70%, etc. for a variation of 50%) by varying the number and materials of the layers 320 under the top layer 310. Typically, in the design of FIG. 7B, only the top layer 310 varies in thickness and the remaining layers 320 are an integer number of quarter waves in thickness. The underlying layers 320 typically are not exposed. Materials which are suitable for the Bragg reflector 130 and/or the stack of the front reflective coating 120 include Ta₂O₅, TiO₂, SiO₂, SiO, Pr₂O₃, Y₂O₃, and HfO₂.

Referring to FIG. 1, each etalon stage 20 introduces a certain group delay τ(ω) and corresponding dispersion D(λ). These quantities are additive. The cumulative group delay produced by all of the stages 20 is the sum of the group delays produced by each etalon stage 20. Similarly, the cumulative group delay produced by all of the stages 20 is the sum of the group delay produced by each etalon stage 20. By appropriately selecting the group delay introduced by each stage 20, a substantially linear group delay curve (or a substantially constant dispersion) can be achieved for the overall system over a certain operating bandwidth.

More specifically, suppose that there are a total of m etalon stages, as shown in FIG. 1. Let ω=2πc/λ=2πf, where A is the wavelength in vacuum and f is the frequency. Each individual stage i is characterized by a reflective coefficient rᵢ and round-trip delay Tᵢ=2 (nᵢ Lᵢ+δᵢ)/c, where nᵢ and Lᵢ are the refractive index and nominal physical length of the body of the etalon (which is assumed to be constructed of a single material in this example) and δᵢ is a variable tuning factor. Eqn. (2) can be expressed for the i-th stage as

$${τ}_{i} ( λ ) = - ( \frac{4 {r}_{i} ( {n}_{i} {L}_{i} + {δ}_{i} )}{c} ) \frac{{r}_{i} + cos ( \frac{4 π ( {n}_{i} {L}_{i} + {δ}_{i} )}{λ} )}{1 + {r}_{i}^{2} + 2 {r}_{i} cos ( \frac{4 π ( {n}_{i} {L}_{i} + {δ}_{i} )}{λ} )} , i = 1 , 2 , … m \qquad ( 4 )$$

As shown in Eqn. (4), the group delay τᵢ is affected by both the reflective coefficient rᵢ and the optical path length (nᵢLᵢ+δᵢ). It is possible to obtain a quasi-linear group delay by superimposing multiple group delay curves with proper phase matching conditions. To illustrate the concept of employing multiple stages to achieve a tunable quasi-linear group delay, the following example uses a three-stage configuration following the architecture in FIG. 1 (with M=m=3). The same idea can be extended to more or fewer stages in a straightforward manner. Increasing the number of stages reduces group delay ripple but at a cost of higher insertion loss and higher material cost. With enough stages, operating bandwidths which exceed 50% of the free spectral range of the etalons are possible.

The total group delay τ_{T}(λ) for an m-stage configuration can be expressed as

$${τ}_{T} ( λ ) = {\sum }_{i = 1}^{m} {τ}_{i} ( λ ) \qquad ( 5 )$$

Hence, the dispersion D of the multi-stage system is related to the total group delay τ_{T}(λ) by

$$D ( λ ) = \frac{ⅆ {τ}_{T} ( λ )}{ⅆ λ} \qquad ( 6 )$$

Generally, better performance can be achieved by adding more degrees of freedom. Better performance typically means larger dispersion tuning range, less residual dispersion and/or ripple (i.e., better dispersion compensation) and/or a wider operating bandwidth. More degrees of freedom typically means more stages 20, more variability in the reflectivity R and/or more variability in the optical path length OPL. Furthermore, with enough variability, a system 10 can be tuned to compensate for different amounts of chromatic dispersion.

The tunability can also compensate for manufacturing variability. For example, consider a situation in which the target reflectivity for a stage is 15%±0.01%. One approach would be to manufacture a constant-reflectivity etalon with a reflectivity of between 14.99 and 15.01%. An alternate approach would be to manufacture a variable reflectivity etalon which is tunable to 15% reflectivity. For example, if the etalon nominally could be tuned over a range of 1%-40%, then even a manufacturing tolerance of +1% (as opposed to ±0.01%) would result in an etalon which could reach the required 15% reflectivity.

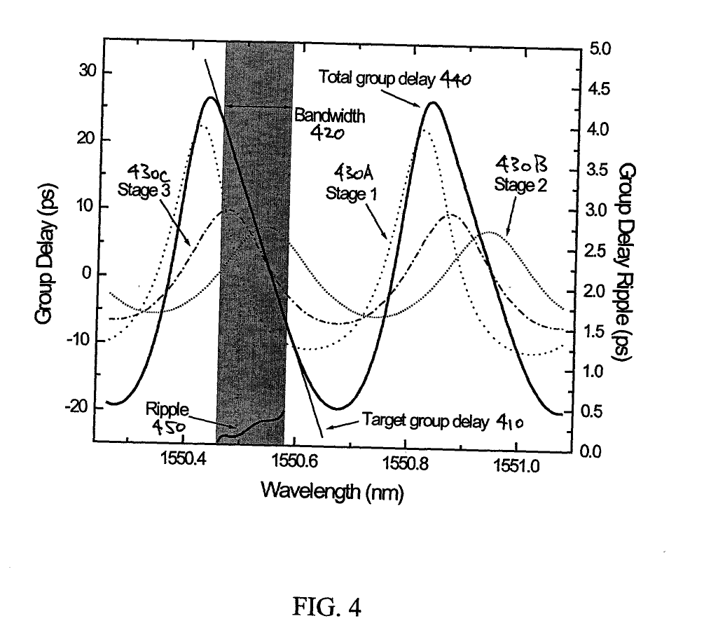

FIGS. 4-6 illustrate the operation of an example system 10 which contains three etalon stages 20, each of which is tunable in reflectivity R and OPL. The reflectivity R is adjusted by tuning the point of incidence 35 of the optical path on the etalon. The phase of the optical path length OPL is adjusted by tuning the temperature of the etalon 20. For convenience, the optical path length will be expressed as OPL 2(n L+δ), where n and L are the refractive index and nominal physical length of the body of the etalon (which is assumed to be constructed of a single material in this example), and δ is a variable tuning factor. More stages typically will result in better dispersion compensation (i.e., less residual dispersion) but at the expense of higher attenuation and cost.

FIG. 4 is a graph of group delay as a function of wavelength for the three-etalon dispersion compensation system. The target group delay for the system is curve 410 over the operating bandwidth 420. Curves 430A, 430B and 430C show the group delay for each of the three stages and curve 440 is the total group delay for the system. Curve 450 shows the residual ripple. Note that each stage is tuned to a different reflectivity R (as evidenced by the different values for the peaks of the individual group delays 430) and to a different optical path length OPL (as evidenced by the different wavelengths at which the individual peaks occur). In fact, by tuning the stages to different values of reflectivity R and optical path length OPL, not only can the system compensate for a specific amount of chromatic dispersion, it can also be tuned to compensate for different amounts of chromatic dispersion.

In addition, since the group delays and dispersions are periodic, the system can compensate for chromatic dispersion on a per-channel or multi-channel basis. In other words, if the dispersion compensation system is used in an application with a predefined and periodic spacing of wavelength bands (e.g., the 50 GHz or 100 GHz spacing of the ITU grid), then the etalons can be designed to have a free spectral range that is approximately equal to the periodic spacing. In this way, the dispersion compensation system can be used over multiple wavelength bands. For example, the system may be designed to cover all of the wavelength bands in one of the commonly used communications bands: the C-band (1528-1565 nm), the L-band (1565-1610 nm) or the S-band (1420-1510 nm).

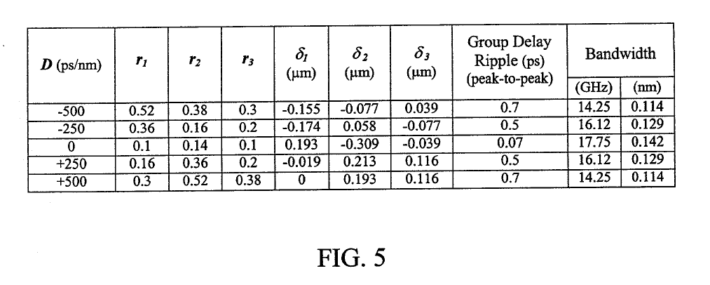

FIG. 5 is a table listing specific parameters for realizing different values of chromatic dispersion. The column D is the target dispersion. The six columns rᵢ and δᵢ are the values of reflective coefficient r (recall, reflectivity R=r²) and OPL tuning factor δ for each of the three stages i. Group Delay Ripple is the peak to peak deviation between the target group delay and the actual group delay realized. The curves in FIG. 4 correspond to the row for D=−250 ps/nm.

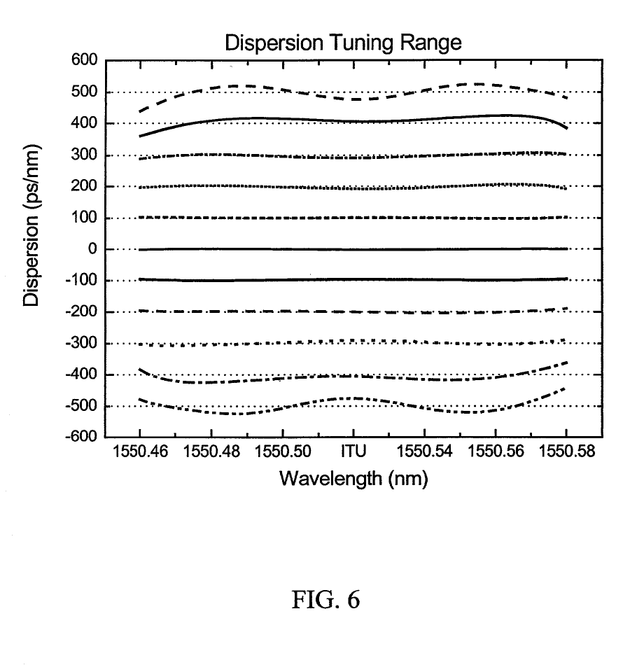

FIG. 6 illustrates the flexibility of this system as it is tuned to dispersion values ranging from −500 to +500 ps/nm. Each curve is generated by tuning the reflectivities and OPL tuning factors to different values. In other words, all of the curves shown in FIG. 6 are generated by a single physical system that is tuned to compensate for different values of dispersion. Note that the system can achieve zero dispersion with low ripple. The curves shown in FIG. 6 are merely examples. The system can be tuned to achieve dispersion values other than those shown, including dispersions with magnitude greater than 500 ps/nm.

In order to realize a specific dispersion, the system is tuned to specific values of reflective coefficient r and OPL tuning factor S. These target values can be determined for each value of dispersion using standard optimization techniques. To a first order, the optimization problem can be described as, for a given operating bandwidth and a given target dispersion D, find the set of parameters (rᵢ, δᵢ) which minimizes some error metric between the actual dispersion realized and the target dispersion or, equivalently, between the actual group delay realized and the target group delay. For constant dispersion, the target group delay will be a linear function of wavelength. Examples of error metrics include the peak-to-peak deviation, maximum deviation, mean squared deviation, and root mean squared deviation. Examples of optimization techniques include the multidimensional downhill simplex method and exhaustive search. Exhaustive search is feasible since the degrees of freedom (rᵢ, δᵢ) typically have a limited range.

There can be multiple solutions for a given value of dispersion and factors in addition to the error metric typically are used to select a solution. For example, one such factor is the sensitivity of the solution to fluctuations in the parameters. Less sensitive solutions are usually preferred. Another factor is the manufacturability or practicality of the solution.

The solutions (rᵢ, δᵢ) for different dispersion values and/or operating bandwidths typically are calculated in advance. They can then be stored and recalled when required. In one embodiment, system 10 includes a lookup table that tabulates the parameters (rᵢ, δᵢ) as a function of dispersion and/or bandwidth. When a specific dispersion compensation is required, the corresponding parameters (rᵢ, δᵢ) are retrieved from the lookup table and the stages are tuned accordingly.

In order to tune the stages, a conversion from the parameters (rᵢ, δᵢ) to some other parameter is typically required. In the example three-stage system described above, the reflective coefficient is converted to a corresponding physical position and OPL tuning factor is converted to a corresponding temperature. There are many ways to achieve this. In one approach, each stage is calibrated and the calibration is then used to convert between (r, δ) and (x, T).

FIGS. 7-11 illustrate various manners in which the reflectivity can vary over the front surface 112 of a variable reflectivity etalon. In FIG. 7A, the front reflective coating 120 includes a top layer 310 of material. The physical thickness of the top layer 310 varies according to location on the front surface 112. In one implementation, the top layer 310 has a constant refractive index and the optical thickness, which is the product of the refractive index and the physical thickness, varies over a range between zero and a quarter wave. In the case where the optical thickness of top layer 310 varies from zero to a quarter wave, the reflectivity will vary from minimum at zero thickness to maximum reflectivity at quarter wave thickness. More generally, the thickness varies over a quarter wave (i.e., from zero to a quarter wave, or from a quarter wave to a half wave, or from a half wave to three quarters wave, etc.), resulting in a monotonic variation of reflectivity with thickness.

In the example of FIG. 7A, the thickness of top layer 310 changes monotonically with the linear coordinate x and does not vary in the y direction (i.e., into or out of the paper). If the optical thickness remains within a quarter wave range, the reflectivity of the front reflective coating 120 will also vary monotonically with x but will be independent of y. The dispersion D will also vary with x and not with y.

The front reflective coating 120 is not restricted to a single layer design. FIG. 7B shows a front reflective coating 120 with multiple layers. In this example, additional layers of material 320A-320C are disposed between the top layer 310 and the front surface 112. In one implementation, these layers 320 are constant refractive index and constant physical thickness. For example, they can be quarter wave layers (or integer multiples of quarter waves). The top layer 310 has a variable physical thickness, as in FIG. 7A. In alternate embodiments, some or all of the intermediate layers 320 may also vary in thickness.

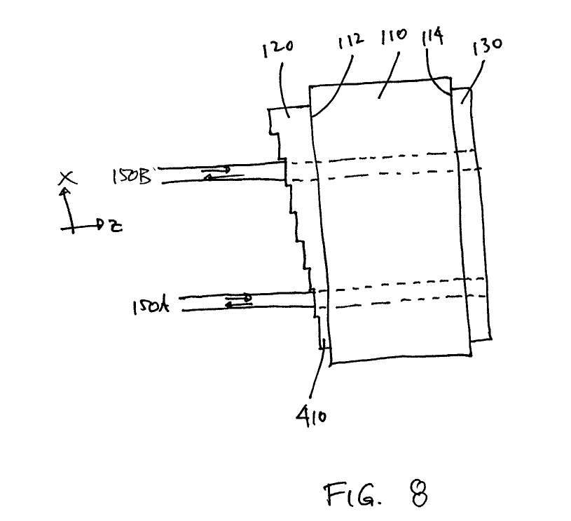

In the examples of FIGS. 7A and 7B, the reflectivity was a continuous function of location on the front surface. In both examples, the thickness of top layer 310 varied continuously with the linear coordinate x. In FIG. 8, the front reflective coating 120 includes a single layer 410 of material that varies in physical thickness in a stepwise fashion. That is, layer 410 has a constant thickness over some finite region, a different constant thickness over a second region, etc. In FIG. 8, these regions are rectangular in shape, with a finite extent in x but running the length of the etalon in y. However, they can be other shapes. For example, hexagonally-shaped regions are well matched in shape to circular beams and can be close packed to yield many different regions over a finite area.

Other variations of thickness as a function of position are possible. In this class of variable reflectivity etalons, the reflectivity of front reflective coating 120 is generally determined by the thickness of the coating (or of specific layers within the coating). Therefore, different reflectivity functions may be realized by implementing the corresponding thickness function. For example, reflectivity can be made a linear function of coordinate x by implementing the corresponding thickness variation in the x direction. The required thickness at each coordinate x can be determined since the relationship between thickness and reflectivity is known, for example by using conventional thin film design tools. The reflectivity and/or thickness can also vary according to other coordinates, including y, the polar coordinates r and θ, or as a two-dimensional function of coordinates.

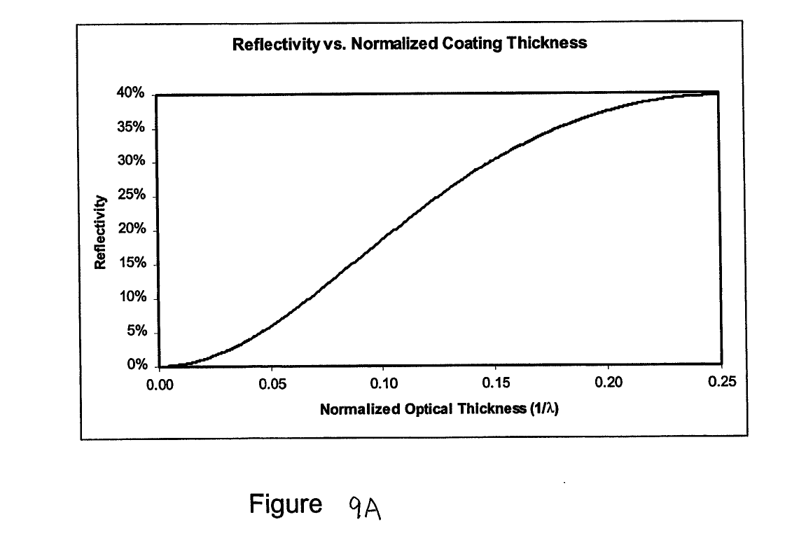

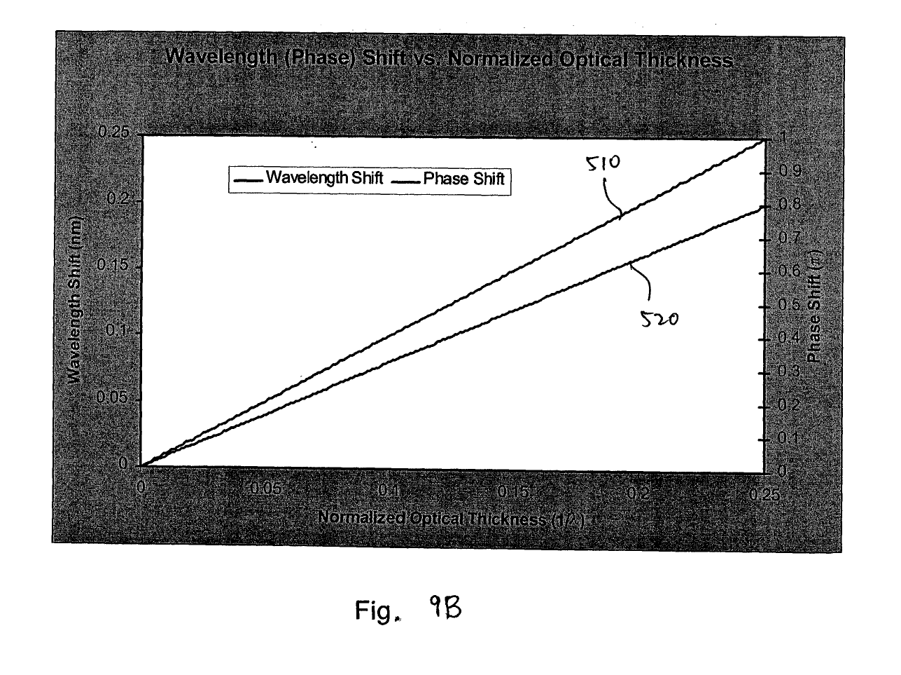

FIGS. 9A-9B are graphs further illustrating the performance of variable reflectivity etalon 100. FIGS. 9A and 9B detail the performance of a 3-layer structure where the top layer 310 which varies in thickness from zero to a quarter wave. However, the general phenomenon illustrated by FIGS. 9A and 9B are also applicable to reflective coatings with other numbers of layers. FIG. 9A graphs reflectivity R as a function of thickness of top layer 310. The thickness is typically measured in reference to optical wavelength. Thus, a normalized optical thickness of 0.10 corresponds to a physical thickness that results in 0.10 wavelength. The normalized optical thickness of 0.00 corresponds to zero thickness and the normalized optical thickness of 0.25 corresponds to a quarter wave thickness. The reflectivity varies from 0%-40%. As mentioned previously, the range of reflectivities can be offset and/or expanded by adding more layers 320.

Referring again to the examples in FIGS. 7-8, these examples vary reflectivity by varying the optical thickness of the front reflective coating 120. However, varying the optical thickness also varies the phase of the OPL. This variation is not significant enough to substantially change the free spectral range of the etalon, so the basic periodicity of the etalon response essentially remains fixed. However, this phase variation is significant enough to affect the location of the peak of the etalon response. In other words, referring to FIGS. 3, the curves 210, 220 and 230 will shift slightly to the right or left with respect to each other as a result of the phase shift introduced by the finite thickness of front reflective coating 120.

FIG. 9B graphs this effect. Curve 510 graphs the phase shift in OPL as a function of the layer thickness, which is normalized in wavelength. Curve 520 graphs the corresponding wavelength shift of the spectral response as a function of the layer thickness, assuming a free spectral range of 50 GHz. For example, at a thickness of a quarter wave, the single layer coating introduces a phase shift of π radians, which shifts the spectral response by 0.2 nm relative to the response at zero thickness.

In some cases, it is undesirable to have a phase shift (and corresponding shift of the spectral response). For example, it may be desirable for all of the spectral responses to have peaks and minima at the same wavelengths, as shown in FIGS. 3A and 3B. In these cases, the phase shift caused by thickness variations in the front reflective coating 120 must be compensated for. In one approach, the transparent body 110 has an optical path length which varies with location, and the variation in the transparent body 110 compensates for the variation caused by the front reflective coating 120.

Referring to FIG. 7A, in one example embodiment, the front and back surfaces 112 and 114 of transparent body 110 are not exactly parallel. Rather, they are slightly tilted so that the body 110 is thicker at point 155B than at 155A, thus compensating for the thinner top layer 310 at point 155B.

In FIG. 10, the transparent body 110 has a constant physical thickness but varying refractive index, thus compensating for phase variations caused by the front reflective coating 120. More specifically, the body 110 includes a gradient index material 111 bonded to a constant index material 113. In the 1.55 μm example described above, Gradium™, (available from LightPath Technology) or liquid crystal is suitable as the gradient index material 111 and fused silica, BK7 or similar glass can be used as the constant index material 113. The refractive index of the gradient index material 111 is higher at point 155B than at 155A. As a result, the optical path length through material 111 is longer at point 155B, thus compensating for the thinner front reflective coating 120.

In an alternate approach, the phase is adjusted by changing the temperature of the etalon 100. Thermal expansion changes the physical dimensions of the etalon, resulting in a corresponding change in optical path lengths. Thus, by changing the temperature of the etalon 100, the dispersion characteristic can also be shifted. In particular, the temperature may be controlled so that a center wavelength of the etalon's spectral response falls at some predefined wavelength.

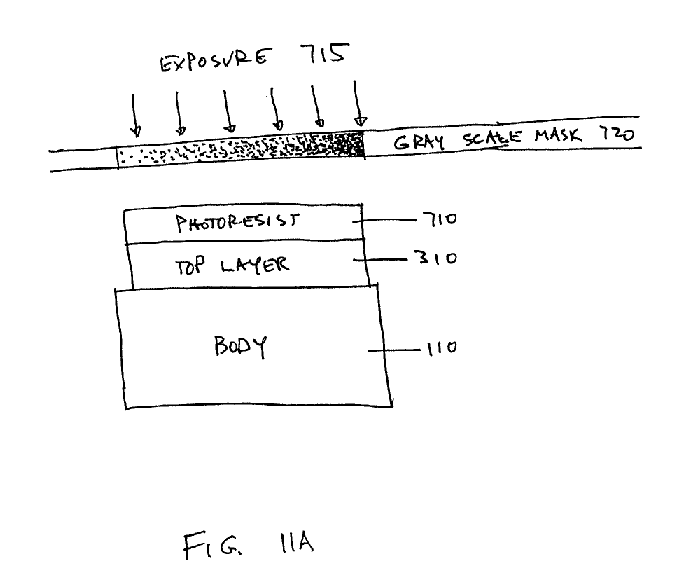

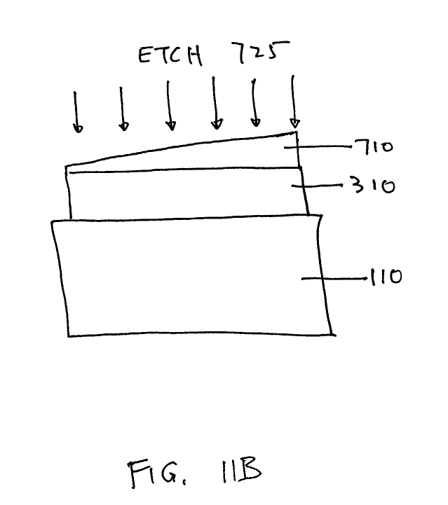

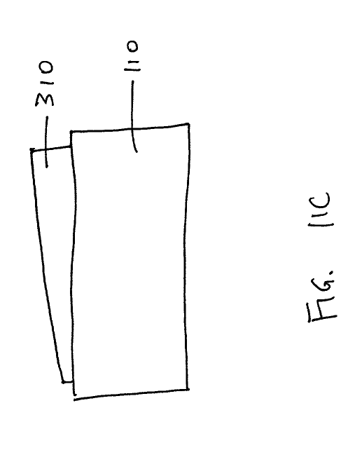

FIGS. 11A-11C illustrate one method for manufacturing the etalon shown in FIG. 7A. Basically, a top layer 310 of uniform thickness is first deposited on the front surface 112 of the etalon body 110. Then, different thicknesses of the top layer 310 are removed according to the location on the front surface. What remains is a top layer 310 of varying thickness.

In FIG. 11A, a uniform top layer 310 has already been deposited on the etalon body 110 using conventional techniques. The top layer 310 has also been coated with photoresist 710. The photoresist 710 is exposed 715 using a gray scale mask 720. Thus, the photoresist receives a variable exposure. In FIG. 11B, the photoresist 710 has been developed. The gray scale exposure results in a photoresist layer 710 of variable thickness. The device is then exposed to a reactive ion etch (RIE). In areas where there is thick photoresist, the etch removes all of the photoresist and a little of the top layer 310 of the front reflective coating. In areas where there is thin photoresist, the etch removes more of the top layer 310. The end result, shown in FIG. 11C is a top layer of varying thickness.

FIGS. 11A-11C illustrate a manufacturing process that uses reactive ion etching although other techniques can be used. For example, in a different approach, other uniform etching techniques or ion milling can be used to remove different thicknesses from the top layer 310. Mechanical polishing techniques or laser ablation may also be used. In one laser ablation approach, a laser is scanned across the top layer 310 and ablates different amounts of material at different locations. The result is a top layer 310 of varying thickness. In a different approach, rather than depositing a top layer 310 of uniform thickness and then removing different amounts of the top layer, a top layer 310 of varying thickness is deposited. Finally, FIGS. 11A-11C describe the manufacture of the etalon in FIG. 7A. However, the techniques described can be used to manufacture other types of variable reflectivity etalons, including those shown in FIGS. 7-10.

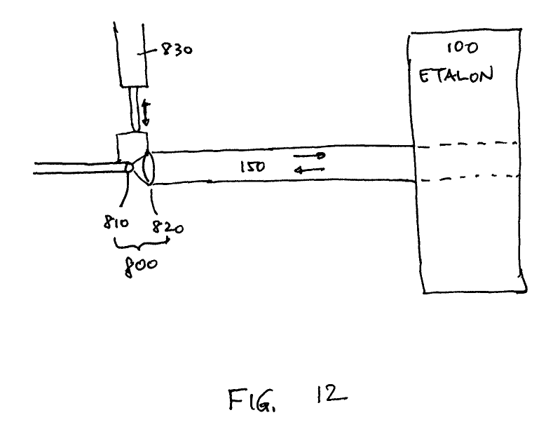

FIGS. 12-16 illustrate different ways to translate the point of incidence of the optical beam 150. In all of these examples, the incoming optical signal is shown as arriving via an optical fiber 810 and collimated by a lens 820 to produce the optical beam 150. This is merely a pictorial representation of the input port 800 (labeled as input port 22 in FIG. 1) for optical beam 150. It is not meant to imply that other designs for the input/output ports cannot be used. For example, the optical beam 150 may arrive in a collimated form, the lens may be integrated onto the fiber, the fiber may be replaced by a waveguide, there may be other intermediate devices (e.g., mirrors, beamsplitters, optical filters), etc. Note that the input port 800 can also serve as the output port. In FIGS. 12-16, the optical signal is shown as arriving via fiber 810, collimated by lens 820, propagates through etalon 100, is re-collected by lens 820 and exits via fiber 810.

FIG. 17 is a top view of an etalon stage that uses separate input and output fibers 810 and 811. In this device, the two fibers 810 and 811 are placed symmetrically about the optical axis of the collimating lens 820. Thus, the optical beam 150 will leave fiber 810, reflect through the etalon 100 and return to fiber 811. The optical beam 150 will not be exactly normally incident on the etalon 100. However, some deviation from normal incidence can be tolerated without significantly affecting the overall performance. A typical tolerance is that the beam is within 0.6° of normal to prevent significant effects due to beam walk off, although actual tolerances will depend on the application. The beam displacement approaches described in FIGS. 12-16 below are also generally applicable to the architecture shown in FIG. 17. One advantage of the dual fiber approach is that a circulator (or other similar device) is no longer required to separate the incoming and outgoing beams.

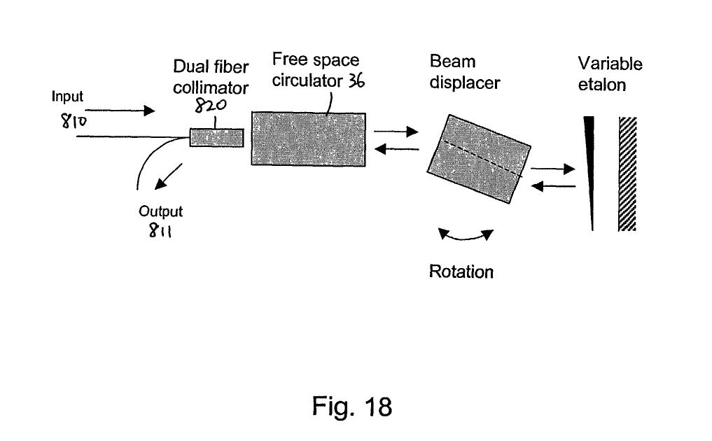

FIG. 18 is a top view of an etalon stage that utilizes a dual fiber collimator 820 and a free space circulator 36. In this device, two fibers 810 and 811 are coupled to a dual fiber collimator 820 which is coupled to the rest of the etalon stage by a free space circulator 36. Thus, an optical beam is input via fiber 810, is collimated by the dual fiber collimator 820 and then enters the remainder of the etalon stage. On the return trip, the optical beam enters the circulator 36 from the opposite direction and, as a result, is directed to output fiber 811 rather than input fiber 810. As with FIG. 17, the beam displacement approaches described in FIGS. 12-16 below are also generally applicable to the architecture shown in FIG. 18. Advantages of this approach include reduced size and lower optical loss.

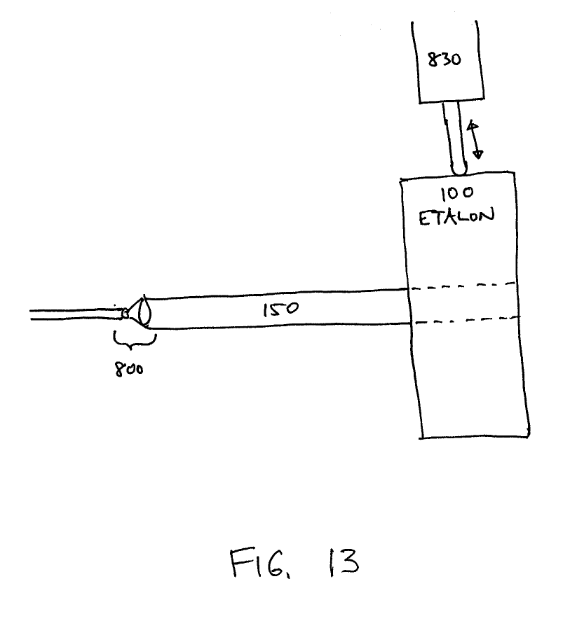

In FIGS. 12-13, beam displacement is achieved by creating relative movement between the input port 800 and the variable reflectivity etalon 100. In FIG. 12, the input port 800 is translated relative to a stationary variable reflectivity etalon 100. In particular, a mechanical actuator 830 moves the fiber 810 and collimating lens 820, thus moving the point of incidence. More generally, an actuator which is physically connected to the input port 800 can be used to translate the input port 800 relative to the etalon 100, thus changing the point of incidence. In FIG. 13, a mechanical actuator 830 is connected to the etalon 100 and translates the variable reflectivity etalon 100 relative to a stationary optical beam 150. In other implementations, both the input port 800 and the etalon 100 can be moved simultaneously.

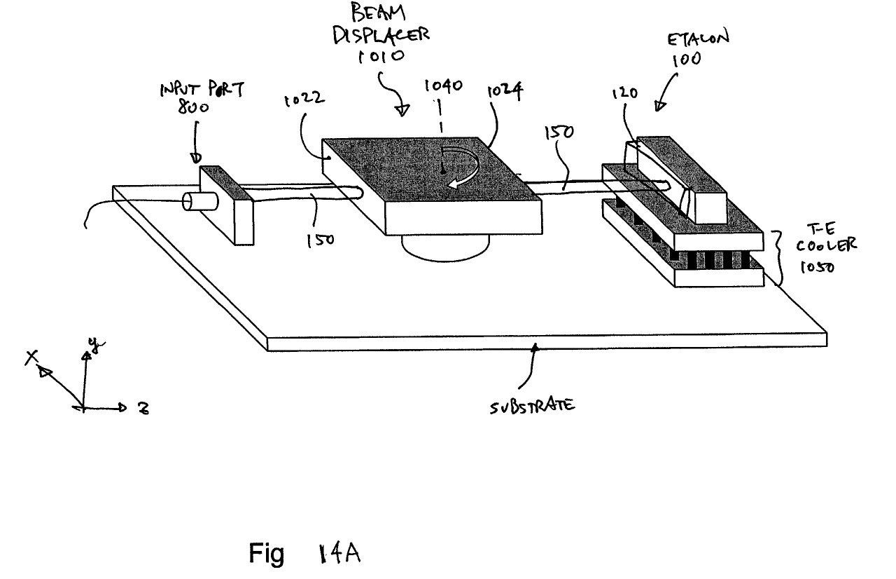

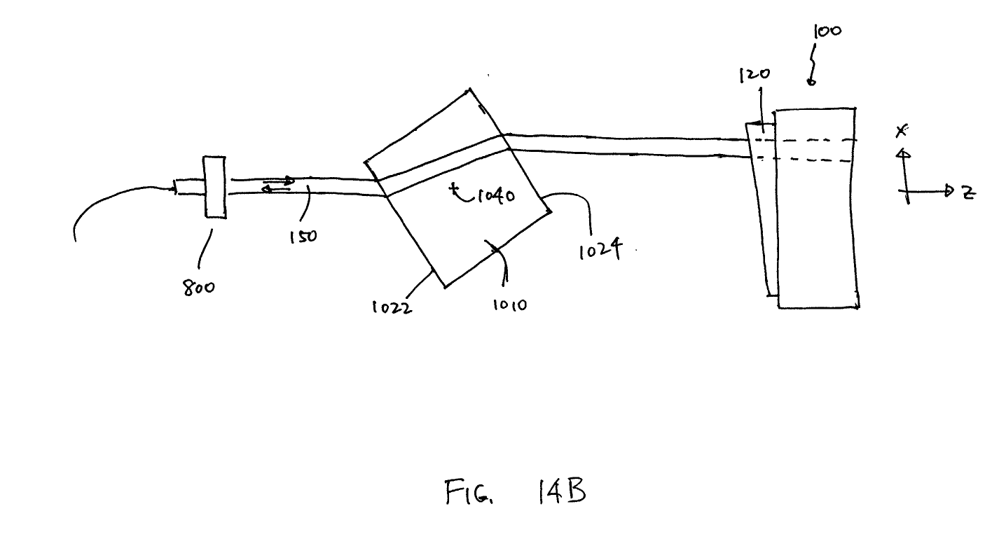

In FIGS. 14-16, the input port 800 and etalon 100 remain in fixed locations relative to each other. A separate beam displacer 1010, 1110, 1210 is located in the optical path between the input port 800 and etalon 100. The beam displacer is used to change the point of incidence of the optical beam 150 to different locations on the etalon's front surface while maintaining normal incidence of the optical beam on the etalon's front surface.

FIGS. 14A-14B are a perspective view and a top view of an etalon stage in which the beam displacer 1010 is rotated in order to change the point of incidence. In this example, the beam displacer 1010 includes a transparent body 1020 that has an input surface 1022 and an output surface 1024. The beam displacer 1010 is located in the optical path of the optical beam 150 and rotates about an axis 1040 which is perpendicular to the direction of propagation of the optical beam 150. In this example, the input and output surfaces 1022 and 1024 are plane-parallel to each other. In FIG. 14, the optical beam 150 propagates in the z direction, the reflectivity of etalon 100 varies in the x direction, and the axis of rotation 1040 is in the y direction.

The beam displacer 1010 operates as follows. The optical beam 150 enters the transparent body 1020 through the input surface 1022 and exits the body 1020 through the output surface 1024. Since the two surfaces 1022 and 1024 are parallel to each other, the exiting beam propagates in the same direction as the incoming beam, regardless of the rotation of the beam displacer 1010. As a result, the exiting beam always propagates in the z direction and the etalon 100 is oriented so that the beam 150 is normally incident upon it. Rotation of the beam displacer 1010 about they axis produces a translation of the optical beam in the x direction due to refraction at the two surfaces 1022 and 1024. The reflectivity of the front reflective coating 120 also varies in the x direction. Thus, different reflectivities for etalon 100 can be realized by rotating the beam displacer 1010.

FIG. 14 also shows the etalon 100 as being mounted on a thermoelectric cooler 1050. The cooler 1050 is in thermal contact with the transparent body of the etalon 100 and is used to control the temperature of the etalon since the temperature affects the free spectral range and OPL tuning factor of the etalon. Other types of temperature controllers may be used in place of the thermoelectric cooler 1050.

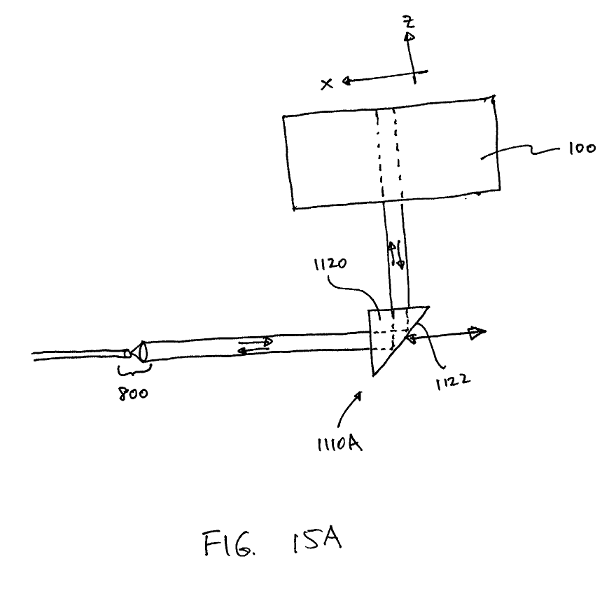

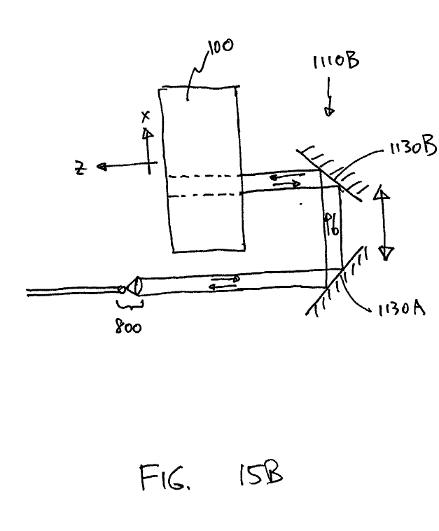

In FIGS. 15A-15B, the beam displacers 1110A and 1110B are based on translatable reflective surfaces. Generally speaking, the optical beam 150 reflects off of at least one reflective surface en route to the etalon 100. By translating the reflective surface, the point of incidence for the optical beam 150 is moved but the normal incidence is maintained. In FIG. 15A, the beam displacer 1110A includes a right angle prism 1120 and the reflective surface is the hypotenuse 1122 of the prism. The optical beam 150 enters the prism, total internally reflects off the hypotenuse 1122 and exits the prism to the etalon 100. By translating the prism 1120, the point of incidence on the etalon can be moved. Note that the prism can be translated in many directions. For example, translating in either the x or z direction will result in movement of the point of incidence.

In FIG. 15B, the beam displacer 1110B includes a pair of mirrors 1130A-B. At each mirror 1130, the optical beam 150 reflects at a right angle. Translating the mirrors 1130 in the x direction moves the point of incidence.

The beam displacers shown in FIG. 15 are merely examples. In both of these cases, mirrors and prisms (or other types of reflective surfaces) can be substituted for each other. Furthermore, it is not necessary that the reflections occur at right angles or that the prism be a right angle prism. Other geometries can be utilized.

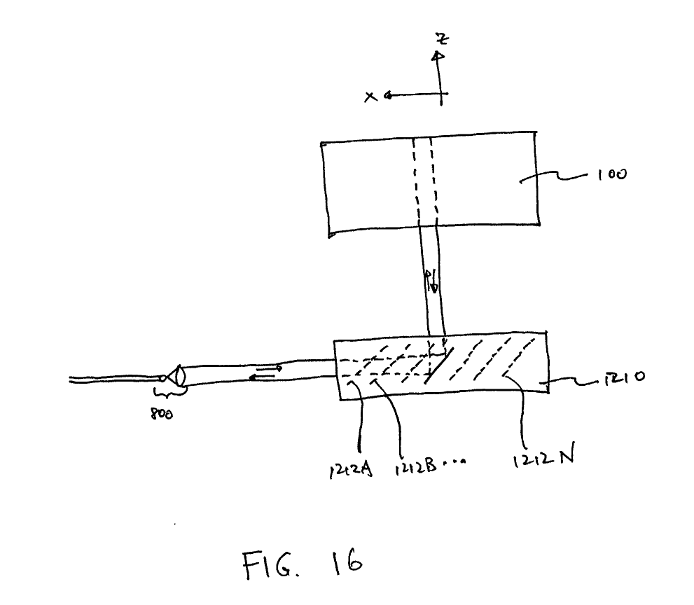

In FIG. 16, the beam displacer 1210 is a MEMS mirror. In this example, the beam displacer 1210 has a number of mirrors that can be turned on and off electrically. By turning on different mirrors, the optical beam 150 is deflected to different points of incidence. More generally, the device has a number of states, each of which directs the optical beam 150 to a different location on the etalon's front surface. Other technologies, including acousto-optics and electro-optics, can also be used.

Although the invention has been described in considerable detail with reference to certain preferred embodiments thereof, other embodiments will be apparent. Therefore, the scope of the appended claims should not be limited to the description of the preferred embodiments contained herein.

What is claimed is:

1. A dispersion compensation system comprising:
a chain of at least one etalon stage, each etalon stage comprising:
an input port;
an output port;
an optical path from the input port to the output port; and
an etalon located in the optical path, the etalon having a front dielectric reflective coating and a back dielectric reflective coating;
wherein:
the output port of one etalon stage is optically coupled to the input port of a next etalon stage in the chain;
in at least one etalon stage, the front reflective coating of the etalon has a reflectivity that varies according to location and a point of incidence of the optical path on the front reflective coating is tunable; and
a chromatic dispersion of the chain of etalon stages is substantially constant over an operating bandwidth.

2. The dispersion compensation system of claim 1 wherein, in each of the etalon stages, the front reflective coating of the etalon has a reflectivity that varies according to location and a point of incidence of the optical path on the front reflective coating is tunable.

3. The dispersion compensation system of claim 2 wherein the chromatic dispersion of the chain of etalon stages can be tuned by tuning the point of incidence of the optical path on the front reflective coating.

4. The dispersion compensation system of claim 3 further comprising:
a lookup table that tabulates point of incidence on the front reflective coating and a phase of the optical path as a function of the chromatic dispersion of the chain of etalon stages.

5. The dispersion compensation system of claim 2 wherein the front reflective coating comprises:
a layer having a physical thickness that varies according to location.

6. The dispersion compensation system of claim 5 wherein the layer is selected from a group consisting of Ta₂O₅, TiO₂, SiO₂, SiO, Pr₂O₃, Y₂O₃ and HfO₂.

7. The dispersion compensation system of claim 2 wherein:
the chain comprises at least two etalon stages; and
in each of the etalon stages, the front reflective coating of the etalon has a reflectivity that varies according to location and a point of incidence of the optical path on the front reflective coating is tunable.

8. The dispersion compensation system of claim 7 wherein:
each etalon is characterized by a free spectral range that is approximately equal to a channel spacing defined by a ITU grid; and
for all free spectral ranges within a preselected communications band, the operating bandwidth is at least a predefined minimum percentage of the channel spacing defined by the ITU grid, wherein the preselected communications band is selected from a group consisting of the C-band (1528-1565 nm), the L-band (1565-1610 nm) and the S-band (1420-1510 nm).

9. The dispersion compensation system of claim 7 wherein:
each etalon is characterized by a free spectral range that is approximately equal to a channel spacing defined by an ITU grid; and
for at least one free spectral range, the operating bandwidth is at least 50% of the channel spacing defined by the ITU grid.

10. The dispersion compensation system of claim 7 wherein:
each etalon is characterized by a free spectral range that is approximately equal to a channel spacing defined by an ITU grid; and
for at least one free spectral range, the chromatic dispersion of the chain of etalon stages is tunable over a range of at least −500 ps/nm to +500 ps/nm over the operating bandwidth.

11. The dispersion compensation system of claim 2 wherein each etalon stage further comprises:
a transparent body having an input surface and an output surface, wherein:
the optical path enters the transparent body through the input surface and exits the transparent body through the output surface and directed to the etalon,
the transparent body is rotatable about an axis perpendicular to a direction of propagation of the optical path; and
rotating the transparent body about the axis translates the point of incidence to different locations on the front reflective coating of the etalon.

12. The dispersion compensation system of claim 2 wherein, in each of the etalon stages, a phase of the optical path in the etalon is variable.

13. The dispersion compensation system of claim 12 wherein each etalon stage further comprises:
a temperature controller coupled to the etalon for controlling a temperature of the etalon, wherein varying the temperature of the etalon varies the phase of the optical path in the etalon.

14. The dispersion compensation system of claim 1 wherein:
the dispersion compensation system is suitable for use in an application with a predefined periodic spacing of wavelength bands;
each etalon is characterized by a free spectral range; and
the free spectral ranges of the etalons are approximately equal to the predefined periodic spacing of the wavelength bands.

15. The dispersion compensation system of claim 1 wherein:
the dispersion compensation system is suitable for use in an application with a predefined periodic spacing of wavelength bands;
each etalon is characterized by a free spectral range; and
the free spectral ranges of the etalons equal a predefined value that varies from the predefined periodic spacing of the wavelength bands.

16. The dispersion compensation system of claim 1 further comprising:
a 3 dB coupler for optically coupling the output port of one etalon stage to the input port of a next etalon stage in the chain, wherein the input port of each etalon stage is collocated with the output port of the etalon stage.

17. The dispersion compensation system of claim 16 wherein the coupler comprises a circulator.

18. The dispersion compensation system of claim 1 further comprising:
an optical coupler for optically coupling the output port of one etalon stage to the input port of a next etalon stage in the chain, wherein the optical coupler has less than 3 dB loss and the input port of each etalon stage is physically separated from the output port of the etalon stage.

19. The dispersion compensation system of claim 1 wherein at least one etalon stage further comprises:
a free space circulator positioned to receive an optical beam from the input port and direct the optical beam to the etalon, and further positioned to receive an optical beam from the etalon and direct the optical beam to the output port, wherein the input port is physically separated from the output port.

20. The dispersion compensation system of claim 1 wherein the at least one etalon stage further comprises:
a beam displacer located in the optical path between the input port and the etalon, wherein the beam displacer varies the point of incidence of the optical path to different locations on the front reflective coating while maintaining normal incidence on the front reflective coating.

21. The dispersion compensation system of claim 20 wherein the beam displacer comprises:
a transparent body having an input surface and an output surface, wherein:
the optical path enters the transparent body through the input surface and exits the transparent body through the output surface and directed to the etalon,
the transparent body is rotatable about an axis perpendicular to a direction of propagation of the optical path; and
rotating the transparent body about the axis translates the point of incidence to different locations on the front reflective coating of the etalon.

22. In a system comprising a chain of at least one etalon stages, each etalon stage including an etalon, a method for compensating for chromatic dispersion, the method comprising:
receiving an optical beam;
in at least one etalon stage, tuning a point of incidence of an optical path on a front reflective coating of the etalon, whereby a reflectivity of the front reflective coating is adjusted; and
propagating the received optical beam through the chain of etalon stages.

23. The method of claim 22 wherein the step of tuning a point of incidence comprises:
in each of the etalon stages, tuning a point of incidence of an optical path on a front reflective coating of the etalon, whereby a reflectivity of the front reflective coating is adjusted.

24. The method of claim 23 wherein the step of tuning the points of incidence comprises:
tuning the points of incidence so that a chromatic dispersion of the chain of etalon stages compensates for a chromatic dispersion in the received optical beam.

25. The method of claim 24 wherein the step of tuning the points of incidence comprises:
storing a lookup table that tabulates point of incidence and temperature of the etalon as a function of amount of chromatic dispersion compensation;
receiving a desired amount of chromatic dispersion compensation;
determining from the lookup table the points of incidence and temperatures that correspond to the desired amount of chromatic dispersion compensation;
tuning the points of incidence to the points of incidence from the lookup table; and
tuning the temperatures of the etalons to the temperatures from the lookup table.

26. The method of claim 23 wherein the chain comprises at least two etalon stages.

27. The method of claim 26 wherein:
each etalon is characterized by a free spectral range that is approximately equal to a channel spacing defined by a ITU grid; and
for all free spectral ranges within a preselected communications band, the operating bandwidth is at least a predefined minimum percentage of the channel spacing defined by the ITU grid, wherein the preselected communications band is selected from a group consisting of the C-band (1528-1565 nm), the L-band (1565-1610 nm) and the S-band (1420-1510 nm).

28. The method of claim 26 wherein:
each etalon is characterized by a free spectral range that is approximately equal to a channel spacing defined by an ITU grid; and
for at least one free spectral range, the operating bandwidth is at least 50% of the channel spacing defined by the ITU grid.

29. The method of claim 26 wherein:
each etalon is characterized by a free spectral range that is approximately equal to a channel spacing defined by an ITU grid; and
for at least one free spectral range, the chromatic dispersion of the chain of etalon stages is tunable over a range of at least −500 ps/nm to +500 ps/nm over the operating bandwidth.

30. The method of claim 23 further comprising:
tuning a phase of the optical path in the etalon.

31. The method of claim 30 wherein the step of tuning a phase of the optical path in the etalon comprises:
tuning a temperature of the etalon, wherein varying the temperature of the etalon varies the phase of the optical path in the etalon.
